(19) United States
(12) Patent Application Publication
(10) Pub. No.: US 2022/0009446 A1
(43) Pub. Date: Jan. 13, 2022

(54) BIOMETRIC AUTHENTICATION SYSTEM FOR VEHICLE

(71) Applicants: TOYOTA JIDOSHA KABUSHIKI KAISHA, Toyota-shi (JP); KABUSHIKI KAISHA TOKAI RIKA DENKI SEISAKUSHO, Niwa-gun (JP)

(72) Inventors: Yuya GOTO, Toyota-shi (JP); Naoyuki TAKADA, Toyota-shi (JP); Hajime SASAKI, Nagoya-shi (JP); Hirokazu ITAKURA, Niwa-gun (JP); Takahiko ANDO, Niwa-gun (JP); Daisuke OGAWA, Niwa-gun (JP)

(73) Assignees: TOYOTA JIDOSHA KABUSHIKI KAISHA, Toyota-shi (JP); KABUSHIKI KAISHA TOKAI RIKA DENKI SEISAKUSHO, Niwa-gun (JP)

(21) Appl. No.: 17/368,125

(22) Filed: Jul. 6, 2021

(30) Foreign Application Priority Data
Jul. 10, 2020 (JP) 2020-119030

(51) Int. Cl. B60R 25/25; B60R 25/04; B60R 25/10

(52) U.S. Cl. CPC B60R 25/252; B60R 2025/1013; B60R 25/10; B60R 25/04

(57) ABSTRACT

A biometric authentication system is configured to perform a biometric authentication operation based on biometric information of an occupant in a passenger compartment of a vehicle and is configured to permit starting of a travel driving force source in the vehicle based on a condition that biometric authentication is established in the biometric authentication operation. The biometric authentication system includes: a biometric information detecting unit configured to detect the biometric information; and a notification unit configured to issue a notification dependent on non-establishment of biometric authentication in the biometric authentication operation to the occupant. The notification unit is configured to issue the notification dependent on the non-establishment of the biometric authentication based on a condition that a brake pedal is depressed at the time of detecting the biometric information by the biometric information detecting unit when the biometric authentication is not established.

### CROSS-REFERENCE TO RELATED APPLICATION

This application claims priority to Japanese Patent Application No. 2020-119030 filed on Jul. 10, 2020, incorporated herein by reference in its entirety.

### BACKGROUND

### 1. Technical Field

The disclosure relates to a biometric authentication system for a vehicle. The disclosure is used, for example, for the purpose of improvement of notification when biometric authentication is not established.

### 2. Description of Related Art

A system for a vehicle that performs a biometric authentication operation for determining whether a person who has performed a starting operation (for example, a starting operation of an engine) is an authorized user (an operation of determining whether detected biometric information corresponds to pre-registered biometric information) is known. A system that performs such a type of biometric authentication operation (a biometric authentication system) is generally used together with an electronic key verification system. Accordingly, it is possible to accurately determine whether a person who has performed a starting operation is an authorized user and to enhance security against vehicle theft.

A system disclosed in Japanese Unexamined Patent Application Publication No. 2019-51803 (JP 2019-51803 A) is known as such a type of biometric authentication system. JP 2019-51803 A discloses a security system in which starting of an engine becomes possible when both key verification and biometric authentication are established, in which a notification indicating that biometric authentication has not been established is issued to a user using indication of a start switch or sound. For example, even if an authorized user performs a biometric authentication operation (an operation of touching a fingerprint sensor with a fingertip, which may be hereinafter referred to as a fingerprint authentication operation) at the time of performing a biometric authentication operation using a fingerprint (a fingerprint authentication operation), it may be determined that information of a detected fingerprint of the fingertip (hereinafter referred to as fingerprint information) is different from registered fingerprint information when the user's fingertip is wounded or the fingertip get wet due to rainfalls or the like, and biometric authentication (fingerprint authentication) may not be established. In this case, a notification indicating that fingerprint authentication has not been established is issued to a user.

### SUMMARY

On the other hand, a biometric authentication system detects a user's biometric information using a biometric information detecting unit that is installed inside a vehicle. For example, when the biometric information detecting unit is a fingerprint sensor, fingerprint information is detected by allowing a user to touch the fingerprint sensor with a fingertip as described above and the fingerprint authentication operation is performed. When fingerprint authentication has not been established, a notification indicating the result is normally issued to a user.

Accordingly, for example, even when a user unintentionally touches the fingerprint sensor without any intention of fingerprint authentication, the fingerprint authentication operation is performed and the notification indicating that fingerprint authentication has not been established is issued to the user when the fingerprint authentication has not been established. In this case, since the user has no intention of fingerprint authentication, the user may feel discomforted due to the notification indicating that fingerprint authentication has not been established.

The inventor et al. of the disclosure noted that the notification indicating that biometric authentication (biometric authentication such as fingerprint authentication) has not been established has to be issued only in a specific case in which biometric authentication has not been established in a state in which a user has an intention of biometric authentication. When a user has no intention of biometric authentication, the inventor et al. studied a means for omitting the notification indicating that fingerprint authentication has not been established.

The disclosure provides a biometric authentication system for a vehicle that can issue a notification based on non-establishment of biometric authentication to a user only when biometric authentication has not been established in a state in which the user has an intention of biometric authentication.

A first aspect of the disclosure provides a biometric authentication system for a vehicle configured to perform a biometric authentication operation based on biometric information of an occupant in a passenger compartment of the vehicle and configured to permit starting of a travel driving force source in the vehicle based on a condition that biometric authentication is established in the biometric authentication operation. The biometric authentication system includes: a biometric information detecting unit configured to detect the biometric information; and a notification unit configured to issue a notification dependent on non-establishment of biometric authentication in the biometric authentication operation to the occupant. The notification unit is configured to issue the notification dependent on the non-establishment of the biometric authentication based on a condition that a brake pedal is depressed at the time of detecting the biometric information by the biometric information detecting unit when the biometric authentication is not established.

The notification based on non-establishment of biometric authentication, mentioned herein, has a concept including at least one of a notification indicating that biometric authentication has not been established and a notification for instructing a user to appropriately perform the biometric authentication operation (such as an appropriate instruction for the biometric authentication operation).

When the travel driving force source of the vehicle is started, a user generally performs an operation of starting the travel driving force source (for example, an operation of pushing a start switch) in a state in which the brake pedal is depressed. Since biometric authentication needs to be established through the biometric authentication operation in order to start the travel driving force source, the user depresses the brake pedal in a state in which the user has an intention of biometric authentication (in a state in which the user is aware that biometric authentication needs to be established). Accordingly, when biometric information is detected by the biometric information detecting unit in a state in which the user is depressing the brake pedal, it can be considered that biometric information is detected in a state in which the user has an intention of biometric authentication. On the other hand, when biometric information is detected by the biometric information detecting unit in a state in which the user is not depressing the brake pedal, it can be considered that there is a likelihood that biometric information will be detected even when the user has no intention of biometric authentication (for example, even when the user unintentionally touches the biometric information detecting unit).

In the first aspect, when biometric authentication has not been established, the notification unit is configured to issue a notification based on non-establishment of biometric authentication on the premise that the brake pedal is depressed when biometric information is detected by the biometric information detecting unit. Accordingly, when biometric authentication has not been established in the biometric authentication operation, the notification based on non-establishment of biometric authentication is issued on the premise (one condition) that the brake pedal is depressed when biometric information is detected by the biometric information detecting unit. In this case, since the user has an intention of biometric authentication, the user does not feel discomforted even when the notification based on non-establishment of biometric authentication is received. On the other hand, when biometric authentication has not been established in the biometric authentication operation, the notification based on non-establishment of biometric authentication is not issued when the brake pedal is not depressed at the time of detecting biometric information using the biometric information detecting unit and the user is not determined as having an intention of biometric authentication. There is a likelihood that the user will feel discomforted when the user has no intention of biometric authentication and receives the notification based on non-establishment of biometric authentication, but the user does not feel discomforted by not issuing the notification based on non-establishment of biometric authentication when the user has no intention of biometric authentication and the biometric authentication has not been established. Accordingly, according to the first aspect, it is possible to issue a notification based on non-establishment of biometric authentication to the user only when biometric authentication has not been established in a state in which the user has an intention of biometric authentication.

A second aspect of the disclosure provides a biometric authentication system including circuitry. The electronic circuit is configured to detect biometric information of an occupant in a passenger compartment of a vehicle, to perform a biometric authentication operation based on the detected biometric information, to permit starting of a travel driving force source in the vehicle when biometric authentication is established in the biometric authentication operation, to issue a notification dependent on non-establishment of biometric authentication in the biometric authentication operation to the occupant, and to issue the notification dependent on the non-establishment of the biometric authentication when the biometric authentication is not established, the biometric information is detected, and a brake pedal is depressed.

According to the first aspect and the second aspect of the disclosure, when biometric authentication has not been established in the biometric authentication operation, the notification unit is configured to issue a notification based on non-establishment of biometric authentication on the premise that the brake pedal is depressed when biometric information is detected by the biometric information detecting unit. Accordingly, according to the first aspect and the second aspect, it is possible to issue a notification based on non-establishment of biometric authentication to the user only when biometric authentication has not been established in a state in which the user has an intention of biometric authentication and to prevent a situation in which the user feels discomforted when the user has no intention of biometric authentication and receives the notification based on non-establishment of biometric authentication.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block diagram schematically illustrating a configuration of a smart entry system including a biometric authentication system according to an embodiment;

FIG. 2 is a perspective view illustrating a start switch;

FIG. 3 is a diagram illustrating a logical circuit of the smart entry system;

FIG. 4 is a flowchart illustrating a flow of operations of the biometric authentication system;

FIG. 5 is a diagram illustrating a first display state on a meter panel when fingerprint authentication has not been established;

FIG. 6 is a diagram illustrating a second display state on a meter panel when fingerprint authentication has not been established;

FIG. 7 is a diagram illustrating a third display state on a meter panel when fingerprint authentication has not been established; and

FIG. 8 is a flowchart illustrating a flow of operations of a biometric authentication system according to a modified example.

### DETAILED DESCRIPTION OF EMBODIMENTS

Hereinafter, an embodiment of the disclosure will be described with reference to the accompanying drawings. In this embodiment, the disclosure is applied as a biometric authentication system that performs biometric authentication (fingerprint authentication) using a fingerprint as biometric information.

### Schematic Configuration of Smart Entry System

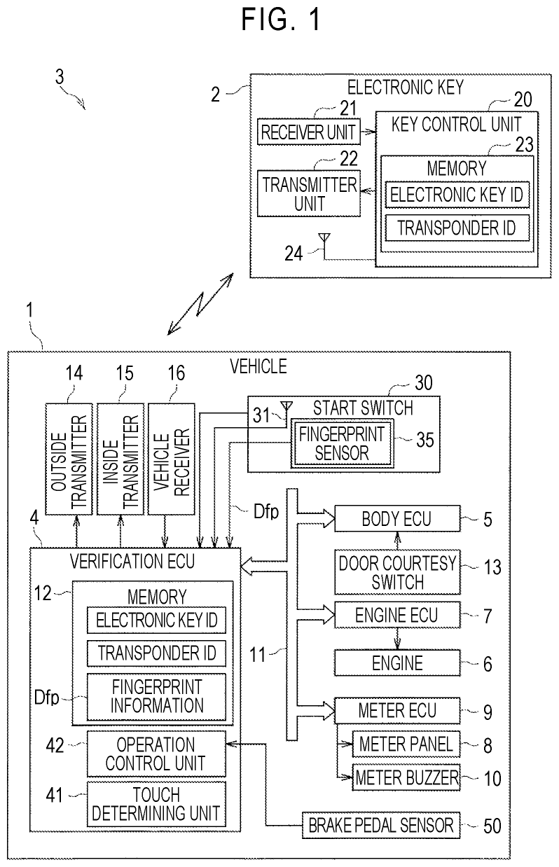

FIG. 1 is a block diagram schematically illustrating a configuration of a smart entry system 3 including a biometric authentication system according to this embodiment. As illustrated in FIG. 1, a vehicle 1 includes a smart entry system (a fingerprint authentication combined electronic key system) 3 that authenticates a user using ID verification of an electronic key 2 and fingerprint authentication together.

The smart entry system 3 according to this embodiment includes a key operation free system and a transponder verification system for ID verification of the electronic key 2. The key operation free system is a system that performs ID verification by short-range radio communication (with a communication range of several m) with the electronic key 2 with communication with the vehicle 1 as a trigger. The transponder verification system has an alternative verification function which is provided to a user when a battery of the electronic key 2 is dead and the ID verification using the key operation free system cannot be performed. Specifically, the transponder verification system is a system that performs ID verification by near-field radio communication (with a communication range of several cm) between the vehicle 1 and the electronic key 2. In the following description, ID verification which is performed by the key operation free system is referred to as “smart verification” and communication at that time is referred to as “smart communication.” ID verification which is performed by the transponder verification system is referred to as “transponder verification” and communication at that time is referred to as “transponder communication.”

The vehicle 1 includes a verification electronic control unit (ECU) 4 serving as an authentication unit, a body ECU 5 that manages power sources of onboard electronic components, an engine ECU 7 that controls an engine (a travel driving force source) 6, and a meter ECU 9 that controls display or the like on a meter panel 8 installed in a passenger compartment (in front of a driver's seat). The meter ECU 9 is also connected to a meter buzzer 10 and controls rumbling of the meter buzzer 10 (for example, rumbling when fingerprint authentication has been established). The ECUs 4, 5, 7, and 9 are connected to each other via a vehicular communication line 11. The communication line 11 includes, for example, a controller area network (CAN) or a local interconnect network (LIN).

The verification ECU 4 performs ID verification of the electronic key 2 and fingerprint authentication. An electronic key ID of the electronic key 2 registered in the vehicle 1 and a transponder ID are written to and stored in a memory 12 of the verification ECU 4. Fingerprint information Dfp which a user has registered in the vehicle 1 is written to and stored (registered) in the memory 12. An example of a method of registering fingerprint information Dfp is a method of transitioning to a registration mode by operating a navigation system which is not illustrated in the vehicle and registering a user's fingerprint information Dfp by touching a fingerprint sensor 35 which will be described later in this state. The body ECU 5 detects a user's boarding based on a detection signal from a door courtesy switch 13 which is installed in a door of the vehicle 1.

The vehicle 1 includes an outside transmitter 14 that transmits radio waves to the outside, an inside transmitter 15 that transmits radio waves to the inside, and a vehicle receiver 16 that receives radio waves. The outside transmitter 14 and the inside transmitter 15 transmit, for example, radio waves of a low frequency (LF) band. The vehicle receiver 16 receives, for example, radio waves in an ultrahigh frequency (UHF) band.

The electronic key 2 includes a key control unit 20 that controls the operation of the electronic key 2, a receiver unit 21 that receives radio waves, and a transmitter unit 22 that transmits radio waves. An electronic key ID which is an ID specific to the electronic key 2 and a transponder ID are written to and stored in a memory 23 of the key control unit 20. The receiver unit 21 receives, for example, LF radio waves. The transmitter unit 22 transmits, for example, UHF radio waves.

In the key operation free system, the outside transmitter 14 and the inside transmitter 15 periodically transmits a wake-up signal in an LF band to search for the electronic key 2. When a response (acknowledgement) to reception of the wake-up signal is received from the electronic key 2, smart communication is set up between the vehicle 1 and the electronic key 2. When smart communication is set up, smart verification is started. The smart verification includes vehicle code verification for authenticating a vehicle code specific to the vehicle 1, challenge response authentication using an encryption key, and electronic key ID verification for authenticating the electronic key ID. The verification ECU 4 receives a response of the electronic key 2 in response to the radio waves transmitted from the outside transmitter 14 and the inside transmitter 15 and considers that smart verification has been established when the smart verification with the electronic key 2 has been established as a whole. The verification ECU 4 recognizes whether the electronic key 2 is located inside or outside the vehicle by ascertaining whether smart communication with the electronic key 2 has been set up by one of the outside transmitter 14 and the inside transmitter 15.

When the electronic key 2 is located outside the vehicle and smart communication between the vehicle 1 and the electronic key 2 (outside smart communication) is set up, smart verification (outside smart verification) is started. In this embodiment, when an operation unit (such as a door handle which is not illustrated) provided in a door of the vehicle 1 is operated in a state in which the outside smart verification has been established, locking/unlocking of the door of the vehicle 1 is performed.

When the electronic key 2 is located inside the vehicle and smart communication between the vehicle 1 and the electronic key 2 (inside smart communication) is set up, smart verification (inside smart verification) is started. In this embodiment, in a state in which a battery of the electronic key 2 is not dead (in a state in which transponder verification is not necessary), the inside smart verification is one of starting permission conditions of the engine 6.

The electronic key 2 includes a communication unit 24 that transmits and receives radio waves to and from the vehicle 1 by transponder communication. For example, a near-field radio communication based on a radio frequency identification (RFID) standard is used as the transponder communication. When wake-up radio waves are received, the communication unit 24 wirelessly transmits a transponder ID using induced electric power thereof.

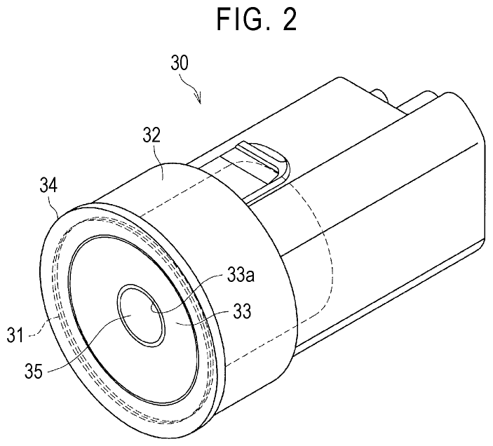

FIG. 2 is a perspective view illustrating a start switch 30 of the vehicle 1. The start switch 30 is provided in front of a driver's seat and is configured to be pushed by a user who sits on the driver's seat. The start switch 30 includes an antenna 31 that receives a transponder ID by near-field radio communication between the electronic key 2 and the communication unit 24. The start switch 30 is operated when a power supply state of the vehicle 1 (for example, ACC ON, IG ON, engine start, or IG OFF) is switched.

The start switch 30 is a push switch including a switch housing 32 serving as a support member and a knob 33 that is provided to reciprocate relative to the switch housing 32. In the switch housing 32, an antenna 31 which is wound on an antenna bobbin (not illustrated) is provided behind a ring-shaped bezel 34 which is formed to surround the knob 33. The antenna 31 is, for example, a coil antenna on which a plurality of antenna wires is wound. The antenna 31 transmits drive radio waves to an area several cm around the antenna 31 when it is supplied with electric power by the verification ECU 4. The start switch 30 is connected to the verification ECU 4 and outputs an operation signal to the verification ECU 4 when the knob 33 is pushed.

In the transponder verification system, transponder communication is performed between the communication unit 24 of the electronic key 2 and the antenna 31 of the start switch 30. When the electronic key 2 is located in the coverage of the drive radio waves from the antenna 31, the communication unit 24 having received the drive radio waves wirelessly transmits a transponder ID with the received drive radio waves as a power source. When the transponder ID transmitted from the communication unit 24 is received by the antenna 31, the verification ECU 4 performs transponder verification. The verification ECU 4 considers that transponder verification has been established when verification between the received transponder ID and the transponder ID stored in the vehicle 1 has been established.

A biometric authentication system of the smart entry system 3 includes a fingerprint sensor (a biometric information detecting unit) 35 that detects fingerprint information Dfp of a user. In this embodiment, the fingerprint sensor 35 is provided in the knob 33 of the start switch 30. In this embodiment, an opening 33a is formed at the center of the knob 33 and the fingerprint sensor 35 is incorporated into the opening 33a. The fingerprint sensor 35 is, for example, a capacitance type sensor. The capacitance type fingerprint sensor 35 detects unevenness of a finger (a fingerprint image) based on a difference in voltage using a phenomenon in which a touched position of a sensor surface is fast discharged and a non-touched position is slowly discharged.

The verification ECU 4 includes a touch determining unit 41 and an operation control unit 42.

The touch determining unit 41 determines whether a touch operation (a fingerprint authentication operation) has been performed on the fingerprint sensor 35. In this embodiment, the fingerprint sensor 35 has a touch detecting function. The fingerprint sensor 35 detects a touch operation, for example, by starting of some of a plurality of capacitance type detection electrodes. For example, the fingerprint sensor 35 starts tens of thousands of detection electrodes when fingerprint information is detected, but starts several detection electrodes when a touch operation is detected. The touch determining unit 41 determines whether a touch operation has been performed on the fingerprint sensor 35 based on a touch detection result from the fingerprint sensor 35.

The operation control unit 42 controls detection of fingerprint information using the fingerprint sensor 35. Specifically, when the touch determining unit 41 determines that a touch operation has been performed on the fingerprint sensor 35, the operation control unit 42 causes the fingerprint sensor 35 to detect fingerprint information. Conditions in which the operation control unit 42 causes the fingerprint sensor 35 to detect fingerprint information may include a condition in which the body ECU 5 determines that a user has boarded, a condition in which inside smart verification with the electronic key 2 has been established, and a combination thereof. The operation control unit 42 acquires fingerprint information Dfp detected by the fingerprint sensor 35 from the fingerprint sensor 35 and performs a fingerprint authentication operation through comparison with pre-registered fingerprint information Dfp. When it is determined that the fingerprint information Dfp acquired by the fingerprint sensor 35 is that of an authorized user, the operation control unit 42 determines that fingerprint authentication has been established. On the other hand, when it is determined that the fingerprint information Dfp acquired by the fingerprint sensor 35 is not that of an authorized user, the operation control unit 42 determines that fingerprint authentication has not been establishment. When the fingerprint authentication has not been established, a notification corresponding thereto needs to be issued to a user according to necessity. In this embodiment, when the fingerprint authentication has not been established, information thereof is transmitted from the operation control unit 42 to the meter ECU 9 and a notification based on non-establishment of the fingerprint authentication is displayed on the meter panel 8 according to necessity. A display mode on the meter panel 8 will be described later.

A brake pedal sensor 50 that detects an operation of depressing a brake pedal which is not illustrated is connected to the operation control unit 42. When a user who sits on a driver's seat depresses the brake pedal, the brake pedal sensor 50 having detected the depression transmits a pedal depression detection signal to the operation control unit 42. The condition in which the brake pedal is depressed is one of starting permission conditions of the engine 6.

In this embodiment, as described above, the condition in which the brake pedal is depressed is used as one of starting permission conditions of the engine 6, but since a method of starting the engine 6 differs between an AT vehicle and an MT vehicle, a condition in which a clutch pedal is depressed (for example, a starting permission condition of the MT vehicle) instead of the condition in which the brake pedal is depressed (for example, a starting permission condition of the AT vehicle) may be used as one of the starting permission conditions of the engine 6. That is, the starting permission condition may differ according to a type of a transmission.

### Logical Circuit of Smart Entry System

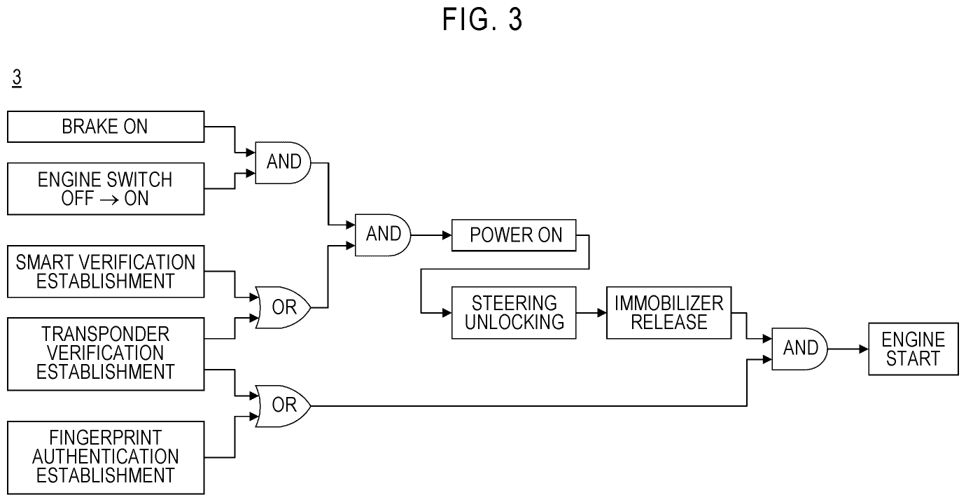

FIG. 3 is a diagram illustrating a logical circuit of the smart entry system 3 according to this embodiment. As illustrated in FIG. 3, in the smart entry system 3 according to this embodiment, the engine 6 is started only when both an operation condition associated with an occupant's operation and a verification condition in the smart entry system 3 are satisfied (AND logic).

The operation condition is that both the condition in which a depression operation (brake ON) is performed as an operation state of the brake pedal detected by the brake pedal sensor 50 and the condition in which the start switch 30 is pushed (start switch OFF ON) are satisfied (AND logic).

The verification condition is that both a condition in which one of smart verification and transponder verification has been established (OR logic) and a condition in which one of transponder verification and fingerprint authentication has been established (OR logic) are satisfied (AND logic). Examples thereof include a state in which smart verification has been established and fingerprint authentication has been established and a state in which only transponder verification has been established. That is, the engine 6 is started when the start switch 30 is pushed while the brake pedal is being depressed in a state in which the verification condition has been satisfied in this way.

Before the engine 6 is started, power-on of the vehicle 1, unlocking of a steering wheel, and release of an immobilizer are performed. The power-on of the vehicle 1, the unlocking of a steering wheel, and the release of an immobilizer are performed on the premise that the start switch 30 is pushed while the brake pedal is being depressed in a state in which one of the smart verification and the transponder verification has been established (OR logic).

### Features of Embodiment

This embodiment is characterized in the notification type on the meter panel (notification means) 8 when the operation control unit 42 determines that fingerprint authentication has not been established.

When fingerprint authentication has not been established, a notification based on the non-establishment of fingerprint authentication is displayed on the meter panel 8 according to necessity. This notification may be a notification indicating that fingerprint authentication has not been established, a notification of an instruction for a user to appropriately perform a fingerprint authentication operation (a biometric authentication operation) (such as an instruction for an appropriate fingerprint authentication operation), or a combination thereof.

Even if a user has no intention of fingerprint authentication and unintentionally touches the fingerprint sensor, the fingerprint authentication operation may be performed and the notification indicating that fingerprint authentication has not been established may be issued to the user when the fingerprint authentication has not been established. In this case, since the user has no intention of fingerprint authentication, the user may feel discomforted due to the notification indicating that fingerprint authentication has not been established.

In this embodiment, in consideration of this problem, the notification indicating that fingerprint authentication has not been established is issued only when fingerprint authentication has not been established in a state in which the user has an intention of fingerprint authentication. Specifically, a notification operation step of issuing a notification based on non-establishment of fingerprint authentication on the meter panel 8 on the premise that the brake pedal is depressed at the time of detecting fingerprint information using the fingerprint sensor 35 when fingerprint authentication has not been established is provided. The reason thereof will be described below.

When the engine 6 is started, a user generally performs an operation of starting the engine 6 (an operation of pushing the start switch 30) in a state in which the user is depressing the brake pedal. Since fingerprint authentication needs to be established through the fingerprint authentication operation in order to start the engine 6, the user depresses the brake pedal in a state in which the user has an intention of fingerprint authentication (in a state in which the user is aware that fingerprint authentication needs to be established). Accordingly, when fingerprint information is detected by the fingerprint sensor 35 in a state in which the user is depressing the brake pedal, it can be considered that fingerprint information is detected in a state in which the user has an intention of fingerprint authentication. On the other hand, when fingerprint information is detected by the fingerprint sensor 35 in a state in which the user is not depressing the brake pedal, it can be considered that fingerprint information is detected even when the user has no intention of fingerprint authentication (for example, even when the user unintentionally touches the fingerprint sensor 35).

In this embodiment, when fingerprint authentication has not been established, the notification operation step of issuing a notification based on non-establishment of fingerprint authentication on the meter panel 8 on the premise that the brake pedal is depressed when fingerprint information is detected by the fingerprint sensor 35 is provided. Accordingly, when fingerprint authentication has not been established in the fingerprint authentication operation, the notification based on non-establishment of fingerprint authentication is issued on the condition (one condition) that the brake pedal is depressed when fingerprint information is detected by the fingerprint sensor 35. In this case, since the user has an intention of fingerprint authentication, the user does not feel discomforted even when the notification based on non-establishment of fingerprint authentication is received. On the other hand, when fingerprint authentication has not been established in the fingerprint authentication operation, the notification based on non-establishment of fingerprint authentication is not issued when the brake pedal is not depressed at the time of detecting fingerprint information using the fingerprint sensor 35 and the user is not determined as having an intention of fingerprint authentication. There is a likelihood that the user will feel discomforted when the user has no intention of fingerprint authentication and receives the notification based on non-establishment of fingerprint authentication. However, according to this embodiment, the user does not feel discomforted by not issuing the notification based on non-establishment of fingerprint authentication in this case (when the user has no intention of fingerprint authentication and the fingerprint authentication has not been established). Accordingly, according to this embodiment, it is possible to issue a notification based on non-establishment of fingerprint authentication to the user only when fingerprint authentication has not been established in a state in which the user has an intention of fingerprint authentication.

### Operation of Biometric Authentication System

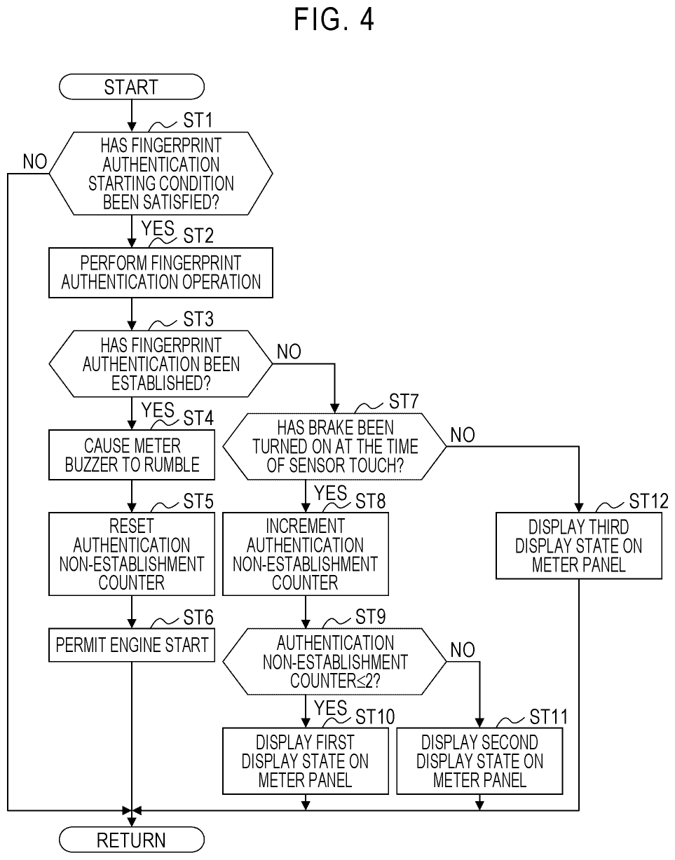

The operation of the biometric authentication system will be described below with reference to the flowchart illustrated in FIG. 4. Herein, the operation of the biometric authentication system after the smart verification has been established and a user who carries the electronic key 2 has boarded the vehicle 1 will be described.

First, in Step ST1, the verification ECU 4 is on standby until fingerprint authentication starting conditions are satisfied and determines whether the fingerprint authentication starting conditions are satisfied. The fingerprint authentication starting conditions in this embodiment include a condition that the body ECU 5 ascertains boarding of the user, a condition that inside smart verification has been established, and a condition that the touch determining unit 41 determines that a touch operation has been performed on the fingerprint sensor 35. When the verification ECU 4 is on standby, the fingerprint sensor 35 waits for detection of a touch operation by activating some of a plurality of capacitance type detection electrodes. When the verification ECU 4 is on standby, the antenna 31 transmits drive radio waves for transponder communication.

When the fingerprint authentication starting conditions are satisfied and the determination result of Step ST1 is YES, Step ST2 is performed. In Step ST2, since all the fingerprint authentication starting conditions are satisfied, the operation control unit 42 of the verification ECU 4 causes the fingerprint sensor 35 to detect fingerprint information. Specifically, when the user touches the knob 33 of the start switch 30, the verification ECU 4 acquires fingerprint information Dfp from the fingerprint sensor 35 which is provided in the knob 33 of the start switch 30. Then, the verification ECU 4 performs a fingerprint authentication operation of ascertaining whether the acquired fingerprint information Dfp is right or wrong. At this time, the verification ECU 4 ascertains whether the fingerprint information Dfp acquired from the fingerprint sensor 35 is right or wrong by comparing the fingerprint information Dfp detected by the fingerprint sensor 35 with the fingerprint information Dfp stored in the memory 12. The verification ECU 4 determines that the fingerprint authentication has been established when the two types of fingerprint information Dfp correspond to each other, and determines that the fingerprint authentication has not been established when the two types of fingerprint information Dfp do not correspond to each other.

In Step ST3, it is determined whether fingerprint authentication has been established in the fingerprint authentication operation of Step ST2.

When the fingerprint authentication has been established and the determination result of Step ST3 is YES, Step ST4 is performed. In Step ST4, the meter buzzer 10 rumbles to notify the user that the fingerprint authentication has been established. Specifically, the meter ECU 9 receives information indicating that the fingerprint authentication has been established from the verification ECU 4 and outputs a rumbling instruction signal to the meter buzzer 10, whereby the meter buzzer 10 rumbles.

Thereafter, in Step ST5, an authentication non-establishment counter which will be described later is reset. The authentication non-establishment counter is a counter which is stored in the memory 12 of the verification ECU 4 and is incremented when it is determined that the fingerprint authentication has not been established in the fingerprint authentication operation. In Step ST5, the authentication non-establishment counter is 0.

Thereafter, in Step ST6, starting of the engine 6 is permitted. That is, when the knob 33 of the start switch 30 is pushed, the engine 6 is started.

On the other hand, when the fingerprint authentication has not been established and the determination result of Step ST3 is NO, Step ST7 is performed. In Step ST7, it is determined whether the brake pedal is depressed (brake ON) when the fingerprint information is being detected by the fingerprint sensor 35 in Step ST2 (when a fingertip touches the fingerprint sensor 35). This determination is performed by determining whether a pedal depression detection signal is transmitted from the brake pedal sensor 50 to the operation control unit 42.

When the brake pedal is depressed at the time of detecting fingerprint information using the fingerprint sensor 35 and the determination result of Step ST7 is YES, the authentication non-establishment counter stored in the memory 12 of the verification ECU 4 is incremented in Step ST8.

In Step ST9, it is determined whether the incremented count value of the authentication non-establishment counter is equal to or less than “2.” That is, when this situation in which the fingerprint authentication operation has been performed in a state in which the brake pedal has been depressed and the fingerprint authentication has not been established is a first time (first after the authentication non-establishment counter has been reset) or a second time, the determination result of Step ST9 is YES.

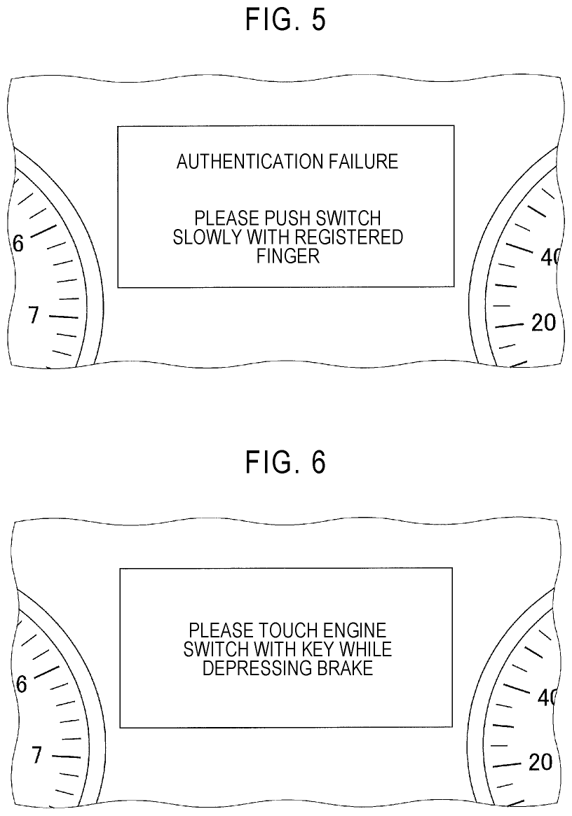

When the determination result of Step ST9 is YES, display in a first display state illustrated in FIG. 5 is performed by the meter panel 8 in Step ST10. In the first display state, for example, text such as “authentication failure” and “please slowly touch switch with registered finger” is displayed on the center of the meter panel 8. This is a notification indicating that fingerprint authentication has not been established and a notification for urging a user to perform a fingerprint authentication operation again, and is an example of a “notification based on non-establishment of biometric authentication” in the claims.

On the other hand, when the count value of the authentication non-establishment counter after being incremented in Step ST8 is equal to or greater than “3” and the determination result of Step ST9 is NO, display in a second display state illustrated in FIG. 6 is performed by the meter panel 8 in Step ST11. In the second display state, for example, text such as “please touch start switch with key while depressing brake” is displayed on the center of the meter panel 8. This is a notification for urging a user to perform transponder verification, and is an example of a “notification based on non-establishment of biometric authentication” in the claims. In the situation in which the count value of the authentication non-establishment counter is equal to or greater than “3” in this way, there is a likelihood that fingerprint information will not be able to be accurately detected by the fingerprint sensor 35 when the user's fingertip is wounded or the fingertip get wet due to rainfalls or the like, the user is urged to perform transponder verification and to start the engine 6.

When display is performed in the first display state in Step ST10 and the second display state in Step ST11, this display is deleted after a predetermined time elapses. Alternatively, the display is deleted when fingerprint information is newly detected by the fingerprint sensor 35.

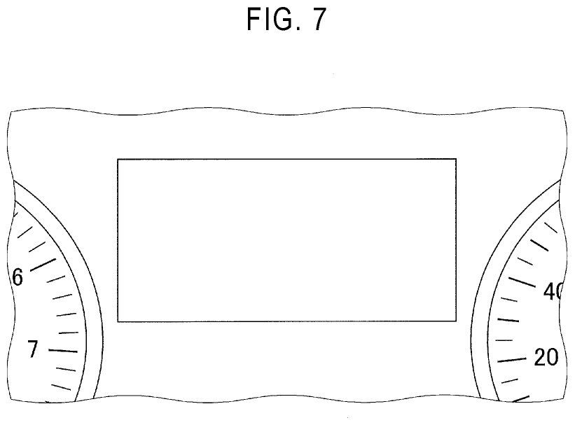

When the brake pedal is not depressed (brake OFF) at the time of detecting fingerprint information using the fingerprint sensor 35, the determination result of Step ST7 is NO and display in a third display state illustrated in FIG. 7 is performed on the meter panel 8 in Step ST12. The third display state is a state in which none is displayed at the center of the meter panel 8 (a notification based on non-establishment of fingerprint authentication is not displayed). That is, when fingerprint authentication has not been established in the fingerprint authentication operation (when the determination result of Step ST3 is NO), the notification based on non-establishment of fingerprint authentication is not issued when the brake pedal is not depressed at the time of detecting fingerprint information using the fingerprint sensor 35 and it is determined that the user has no intention of fingerprint authentication.

The count value of the authentication non-establishment counter incremented in Step ST8 is reset in Step ST5 when it is determined in Step ST3 that fingerprint authentication has been established. Here, the count value of the authentication non-establishment counter is reset when it is determined that fingerprint authentication has been established, but the count value of the authentication non-establishment counter may be reset when the user is separated away from the vehicle 1 or the like and the various ECUs enter a low power consumption mode (also referred to as a sleep state) or the count value of the authentication non-establishment counter may be reset when the transponder verification has been established.

### Advantages of Embodiment

As described above, in this embodiment, when fingerprint authentication has not been established in the fingerprint authentication operation, the notification operation step (Steps ST10 and ST11) of displaying a notification based on non-establishment of fingerprint authentication on the meter panel 8 on the premise that the brake pedal is depressed when fingerprint information is detected by the fingerprint sensor 35 is provided. Accordingly, it is possible to issue a notification based on non-establishment of fingerprint authentication to the user only when fingerprint authentication has not been established in a state in which the user has an intention of fingerprint authentication and to prevent a situation in which the user feels discomforted when the user has no intention of fingerprint authentication and receives the notification based on non-establishment of fingerprint authentication.

### Modified Example

A modified example will be described below. This modified example is characterized in display on the meter panel 8 in a state in which fingerprint authentication is not normally established when a user wears a glove or the like. The configuration of the smart entry system 3 is the same as that in the aforementioned embodiment and only display on the meter panel 8 will be described below.

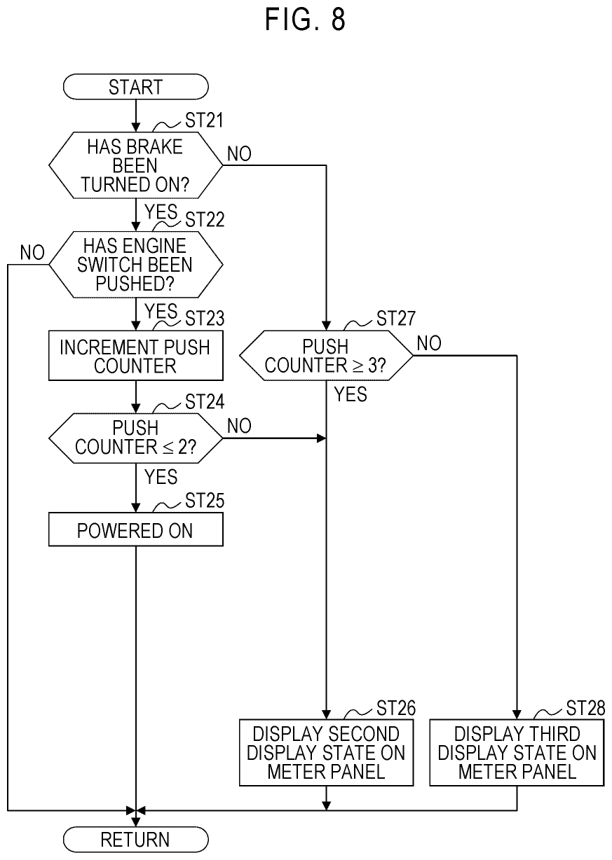

FIG. 8 is a flowchart illustrating the operation of a biometric authentication system according to this embodiment. This flowchart illustrates the operation of the biometric authentication system after smart verification has been established and a user who carries the electronic key 2 has boarded the vehicle 1.

First, in Step ST21, it is determined whether the brake pedal is depressed (brake ON). This determination is also performed by determining whether a pedal depression detection signal is transmitted from the brake pedal sensor 50 to the operation control unit 42.

When the brake pedal is depressed and the determination result of Step ST21 is YES, it is determined in Step ST22 whether the start switch 30 is pushed. This determination is performed by determining whether a signal (an engine start request signal) from the start switch 30 is transmitted to the verification ECU 4.

When the start switch 30 is pushed and the determination result of Step ST22 is YES, a push counter which is stored in the memory 12 of the verification ECU 4 is incremented in Step ST23. The push counter is a counter which is incremented when the start switch 30 is pushed.

In Step ST24, it is determined whether the count value of the push counter is equal to or less than “2” after being incremented. That is, when this situation in which the start switch 30 is pushed in a state in which the brake pedal has been depressed is a first time (first after the push counter has been reset) or a second time, the determination result of Step ST24 is YES.

When the determination result of Step ST24 is YES, the vehicle 1 is powered on in Step ST25. In the state in which the vehicle 1 is powered on, electronic components of the vehicle 1 can operate but the engine 6 cannot be started (the engine 6 is not started even when the start switch 30 is pushed).

On the other hand, when the count value of the push counter after being incremented in Step ST23 is equal to or greater than “3” and the determination result of Step ST24 is NO, display in the second display state illustrated in FIG. 6 is performed by the meter panel 8 in Step ST26. In the second display state, as described above, for example, text such as “please touch start switch with key while depressing brake” is displayed on the center of the meter panel 8. This is a notification for urging a user to perform transponder verification, and is an example of a “notification based on non-establishment of biometric authentication” in the claims.

On the other hand, when the brake pedal is not depressed and the determination result of Step ST21 is NO, it is determined in Step ST27 whether the count value of the push counter is equal to or greater than “3” (for example, whether the operation of pushing the start switch 30 has been performed three or more times in a state in which the brake pedal is not depressed). When the count value of the push counter is equal to or greater than “3” and the determination result of Step ST27 is YES, display in the second display state illustrated in FIG. 6 is performed by the meter panel 8 in Step ST26. In the second display state, as described above, a notification for urging a user to perform transponder verification is displayed. In this way, in the state in which the count value of the push counter is equal to or greater than “3,” the operation of depressing the brake pedal is not performed, but since the user can be considered to have an intention of fingerprint authentication (an intention of starting the engine 6), the user is urged to perform transponder verification and to start the engine 6.

On the other hand, when the count value of the push counter is less than “3” in the determination of Step ST27 and the determination result of Step ST27 is NO, display in the third display state illustrated in FIG. 7 is performed on the meter panel 8 in Step ST28. The third display state is a state in which none is displayed at the center of the meter panel 8 (a notification based on non-establishment of fingerprint authentication is not displayed). That is, when the brake pedal is not depressed and it is determined that the user has no intention of fingerprint authentication (when the count value of the push counter is less than “3”), the notification based on non-establishment of fingerprint authentication is not displayed.

Since the aforementioned operations are performed, an example of “a notification unit issues a notification based on non-establishment of biometric authentication” in the claims is the operation of Step ST26 when the determination result of Step ST21 is YES in this modified example.

In this modified example, only when fingerprint authentication has not been established in a state in which the user has an intention of fingerprint authentication, a notification based on non-establishment of fingerprint authentication can be issued to the user. Particularly, in this modified example, when the brake pedal is not depressed and the count value of the push counter is equal to or greater than “3,” the user is considered to have an intention of fingerprint authentication and a notification based on non-establishment of fingerprint authentication can be displayed on the meter panel 8 for the user.

### Other Embodiments

The disclosure is not limited to the aforementioned embodiment and the aforementioned modified example and can be subjected to all modifications and applications without departing from the scope of the claims or the scope equivalent to the scope of the claims.

For example, in the aforementioned embodiment and the aforementioned modified example, the disclosure is applied as a biometric authentication system that performs fingerprint authentication as biometric authentication. However, the disclosure is not limited thereto and a voiceprint, a face, a vein, an iris of an eyeball, a retina, or the like may be used as biometric authentication.

In the aforementioned embodiment and the aforementioned modified example, the fingerprint sensor 35 is of a capacitance type, but may be of an optical type or an electrolysis strength type. The fingerprint sensor 35 may be provided at a position other than the start switch 30.

In the aforementioned embodiment and the aforementioned modified example, a notification based on non-establishment of fingerprint authentication is displayed on the meter panel 8. The disclosure is not limited thereto and may be performed using the start switch 30 or the electronic key 2. For example, by flickering a light built in the start switch 30 or generating sound (sound from a built-in speaker) or vibration (vibration from a built-in vibration element) from the electronic key 2, non-establishment of fingerprint authentication may be notified.

The disclosure is applicable to a biometric authentication system that issues a notification based on non-establishment of biometric authentication to a user when the biometric authentication has not been established.

What is claimed is:

1. A biometric authentication system for a vehicle configured to perform a biometric authentication operation based on biometric information of an occupant in a passenger compartment of the vehicle and configured to permit starting of a travel driving force source in the vehicle based on a condition that biometric authentication is established in the biometric authentication operation, the biometric authentication system comprising:
a biometric information detecting unit configured to detect the biometric information; and
a notification unit configured to issue a notification dependent on non-establishment of biometric authentication in the biometric authentication operation to the occupant,
wherein the notification unit is configured to issue the notification dependent on the non-establishment of the biometric authentication based on a condition that a brake pedal is depressed at the time of detecting the biometric information by the biometric information detecting unit when the biometric authentication is not established.

2. A biometric authentication system comprising circuitry configured to:
detect biometric information of an occupant in a passenger compartment of a vehicle;
perform a biometric authentication operation based on the detected biometric information;
permit starting of a travel driving force source in the vehicle when biometric authentication is established in the biometric authentication operation;
issue a notification dependent on non-establishment of biometric authentication in the biometric authentication operation to the occupant; and
issue the notification dependent on the non-establishment of the biometric authentication when the biometric authentication is not established, the biometric information is detected, and a brake pedal is depressed.
